(19) United States
(12) Patent Application Publication
(10) Pub. No.: US 2010/0028229 A1
(43) Pub. Date: Feb. 4, 2010

(54) OXYGEN REMOVAL

(75) Inventors: Peter John Herbert Carnell, Stockton- on- Tees (GB); Paul John Collier, Reading (GB); Suzanne Rose Ellis, Reading (GB); Martin Fowles, Whitby (GB); Raymond Anthony Hadden, Durham (GB)

Correspondence Address: RATNERPRESTIA, P.O. BOX 980, VALLEY FORGE, PA, 19482, US

(73) Assignee: JOHNSON MATTHEY PUBLIC LIMITED COMPANY, London (GB)

(21) Appl. No.: 12/530,076

(22) PCT Filed: Feb. 28, 2008
(86) PCT No.: PCT/GB2008/050137

§ 371 Date: Sep. 4, 2009

(30) Foreign Application Priority Data
Mar. 5, 2007 (GB) 0704107.2

(51) Int. Cl. B01D 53/46; B01J 19/00; B01J 8/00

(52) U.S. Cl. 423/219; 422/129; 422/188

(57) ABSTRACT

A process for reducing free oxygen in a gaseous hydrocarbon stream comprises the step of passing the gaseous hydrocarbon stream over a material comprising a metal selected from Ni, Co, Cu, Fe, Mn or Ag in a reduced state so that oxygen present in said stream reacts with the metal, wherein the metal in the reduced state is formed by,
(i) withdrawing a portion of the hydrocarbon stream,
(ii) forming a gas mixture containing hydrogen from the hydrocarbon portion, and
(iii) passing the gas mixture containing hydrogen over the material containing the metal in reducible form.

This invention relates to a process for removing free oxygen from gaseous hydrocarbons.

Gaseous hydrocarbons such as natural gas, LPG or LNG may contain small amounts of free oxygen, i.e. O₂ gas. Free oxygen may be introduced inadvertently, by use of a gaseous hydrocarbon as a stripper gas or by blending with air. For example, natural gas may contain free oxygen as a result of poor purging after maintenance, air leakage into compressor pumps, use of natural gas as stripper gas for gas dryers, use of natural gas as stripper gas for water injection and from dissolved air in fluids injected down hole. The amount of free oxygen in the natural gas recovered from these processes may be in the range 70 to 100 ppm (vol). Alternatively, free oxygen may be introduced into LPG or LNG by blending processes with air to reduce calorific value in so-called “air balancing”. The amount of free oxygen introduced into LPG or LNG in this way may be as much as 0.5% by volume or higher.

The presence of free oxygen is potentially hazardous although a main concern in processing gaseous hydrocarbons containing free oxygen is corrosion to process equipment, resulting in costly replacement and maintenance. Furthermore free oxygen can react with hydrogen sulphide that may be present in the gas to form elemental sulphur; it can also cause damage to molecular sieves used in gas drying by exothermic reaction with carbon residues. Free oxygen can cause undesirable oxidation of glycol solvents used in drying plants, or cause heat-stable salts to form in acid gas removal systems, leading to effluent problems in the purge streams. It is therefore desirable to limit free oxygen content to a few ppm or less.

Direct combustion of the free oxygen by heating the gaseous hydrocarbon over a combustion catalyst requires temperatures of 300° C. or more and it is not practical to heat large volumes of gas to this temperature and then cool it for subsequent use.

We have devised a process that overcomes these problems.

Accordingly the invention provides a process for reducing free oxygen in a gaseous hydrocarbon stream, comprising the step of passing the gaseous hydrocarbon stream over a material comprising a metal selected from Ni, Co, Cu, Fe, Mn or Ag in a reduced state so that oxygen present in said stream reacts with the metal, wherein the metal in the reduced state is formed by,
(i) withdrawing a portion of the hydrocarbon stream,
(ii) forming a gas mixture containing hydrogen from the hydrocarbon portion, and
(iii) passing the gas mixture containing hydrogen over the material containing the metal in reducible form.

By “reduced state” we mean that the metal is in elemental or a lower oxide form such that it is oxidisable by free oxygen to metal oxide or a higher valency metal oxide. Furthermore, “in reducible form” means that the metal is in an oxidised state, e.g. the metal oxide.

The hydrogen-containing gas mixture may be formed by catalytic dehydrogenation (cDH) of C2+ alkanes in the hydrocarbon over oxidic or precious metal catalysts to generate hydrogen and olefins. By “C2+ alkanes” we mean alkanes of formula CₙH₂ₙ₊₂ having n≧2, preferably one or more of ethane, propane, butane, pentane and hexane. The main types of alkane dehydrogenation catalysts are Group 8 metals; particularly platinum/tin supported on ZnAl₂O₄, MgAl₂O₄ or alumina, chromium oxides on alumina or zirconia and gallium either as a supported oxide or present in zeolites. Light paraffins are best dehydrogenated using promoted Pt/Sn on alumina and Cr₂O₃ on alumina above 500° C., preferably above 600° C. Long chain paraffins are best dehydrogenated using promoted Pt/Sn on alumina at temperatures between 400-500° C. While effective for forming hydrogen from hydrocarbons, in order to maintain activity, a periodical regeneration of the catalyst with air may be necessary to burn off carbon deposits (coke).

The hydrogen containing gas mixture may comprise one or more gases that are inert over the material containing the metal in reducible form, such as nitrogen or may comprise another reducing gas. Preferably the hydrogen-containing gas further comprises carbon monoxide.

For example, a hydrogen- and carbon monoxide-containing gas mixture may be formed by partial combustion of the hydrocarbon. Partial combustion of the hydrocarbon with an oxygen-containing gas, such as air, oxygen or oxygen-enriched air produces a gas mixture containing hydrogen and carbon monoxide as well as other gases such as unreacted C2+ hydrocarbons, methane, carbon dioxide and nitrogen. Partial combustion, also termed partial oxidation, maybe carried out using any known partial oxidation process. Partial combustion of a hydrocarbon may be performed by flame combustion in a burner using an oxygen-containing gas in the absence of a combustion catalyst, by so-called non-catalytic partial oxidation (POx), or preferably may be performed at lower temperatures in the presence of a partial oxidation catalyst by so-called catalytic partial oxidation (cPOx). In cPOx, the catalyst is preferably a supported Ni, Rh, Pd or Pt catalyst having <20% wt metal or alloy combinations of these metals, on an inert support such as alumina, silica, titania or zirconia or a Rh or PtRh catalyst, on supports containing ceria.

Alternatively, a hydrogen- and carbon monoxide-containing gas mixture may be formed by autothermal reforming (ATR) comprising oxidising a hydrocarbon, usually a gaseous hydrocarbon, with an oxygen containing gas in the presence of steam, and steam reforming the resulting gas mixture containing unreacted hydrocarbon over a steam reforming catalyst to produce a gas mixture containing hydrogen and carbon oxides (carbon monoxide and carbon dioxide). In autothermal reforming therefore, steam may be added with the hydrocarbon and/or oxygen-containing gas. The oxidation step, which may be performed catalytically, is exothermic and generates the heat required by the endothermic steam reforming reactions. Precious metal oxidation catalysts are preferred. Catalysts used in reforming the hydrocarbon may include one or more of Ni, Pt, Pd, Ru, Rh and Ir supported at levels up to 10% wt on oxidic supports such as silica, alumina, titania, zirconia, ceria, magnesia or other suitable refractory oxides, which may be in the form of pellets, extrudates, cellular ceramic and/or metallic monolith (honeycomb) or ceramic foam or other support structures offering mechanical strength and low pressure drop. In a preferred embodiment, the oxidation and steam reforming reactions are catalysed, more preferably over the same catalyst composition so that one catalyst provides both functions. Such catalysts are described in WO 99/48805 and include Rh or Pt/Rh on a refractory supports comprising Ce and/or Ce/Zr-containing mixtures. The process may be operated at inlet temperatures in the range 250-550° C. and outlet temperatures in the range 600-800° C. depending on the amount of preheat and O₂:C:H₂O ratio, and, where operated before a compression stage, pressures of up to typically about 3 bar abs. Post compression, the pressure may be up to 150 bar abs or higher.

As well as combustion and steam reforming reactions, the water-gas-shift reaction takes place over the reforming catalyst. Thus the reactions taking place in an autothermal reformer, where the hydrocarbon comprises methane include;

CH₄+2O₂→CO₂+2H₂O

CH₄+H₂O→CO+3H₂

CO+H₂O→CO₂+H₂

However, autothermal reforming requires a supply of water for steam generation, which may not be practical in e.g. offshore installations. In such cases, hydrogen formation by cDH, POx or CPOx may be preferred. Alternatively, a water recycle system whereby unreacted steam is condensed from the hydrogen-containing gas and recycled to the reforming step may be employed.

Whereas a hydrogen- and carbon monoxide-containing gas mixture may be formed by steam reforming alone, this is not preferred.

If desired, the reformed gas mixture containing hydrogen, steam and carbon oxides (CO and CO₂) may be cooled and passed over a water-gas-shift catalyst that reacts carbon monoxide with steam to increase the hydrogen content of the gas mixture according to the following equation.

CO+H₂O [symbol] H₂+CO₂

The water-gas shift catalyst may be precious metal-based, iron-based or copper-based. For example a particulate copper-zinc alumina low-temperature shift catalyst containing 25-35% wt CuO, 30-60% wt ZnO and 5-40% Al2O3% may be used at temperatures in the range 200-250° C. Alternatively the water gas-shift catalyst may be Pt on ceria or titania.

Where it is desired to use a carbon monoxide-containing gas as the reducing gas the water-gas shift step may be omitted.

Whether hydrogen formation is by ATR, POx or cPOx, with or without the water-gas shift reaction, it may be desirable to cool the resulting gas mixture before contacting it with the material containing metal in reducible form. Preferably the temperature of the gas mixture is ≦300° C., more preferably ≦200° C., more preferably ≦150° C. when it is contacted with the material containing metal in reducible form. Cooling of the gas mixture may be effected using known heat exchanger technology. For example the gas mixture may be cooled using water under pressure in high and medium pressure steam generation.

The material containing metal in the reduced state is formed by passing the gas mixture containing hydrogen over the material. The material containing metal in the reduced form may also have potential as a catalyst, and hence may also be termed a catalyst. The hydrogen containing gas mixture may be passed continuously or periodically to the material as required to maintain sufficient activity to remove or reduce the amount of free oxygen to e.g. 5 ppm or less. Preferably the hydrogen-containing gas mixture is passed periodically to the material containing reducible metal. For example, on start-up, a portion of the hydrocarbon containing free oxygen is withdrawn and used to form the hydrogen containing gas mixture that is then used to reduce the Co, Ni, Cu or Fe material to active form. The hydrocarbon containing free oxygen may then be passed through the reduced material for a period of time, which may be days or months depending upon the free oxygen content of the hydrocarbon. The free-oxygen content of the hydrocarbon passing through the material may be monitored continually so that the point at which the material is required to be regenerated may be determined. For regeneration, a portion of the hydrocarbon containing free oxygen is withdrawn and used to generate the hydrogen containing gas which is then used to re-reduce the material.

The Ni, Co, Cu, Fe, Mn or Ag in the material may be in elemental or lower oxide form. One or more reducible metals may be present. Preferably the metal is in elemental form. The free oxygen present in the hydrocarbon may then be removed from the hydrocarbon by oxidation reactions. The oxidation reactions may proceed according to the following equations;

½O₂+M→MO, (where M=Ni, Co, Cu, Fe or Ag in elemental form).

½O₂+3CoO→Co₃O₄

½O₂+2FeO→Fe₂O₃

½O₂+MnO→MnO₂

The material may comprise Ni, Co, Cu, Fe, Mn or Ag supported on a suitable solid support. The effectiveness of the material in forming the respective oxide, and the subsequent reduction of it back to the metal, can be strongly influenced by the choice of support. Preferred supports include alumina, including transition alumina, silica, titania, zirconia, ceria, zinc oxide and combinations of these. More suitable and less suitable combinations of reducible metal and support are known. For example the formation of Co aluminate spinels can, if formed under the oxidation conditions, reduce the ability of the oxide to be reduced.

The material may be particulate or in the form of a foam, monolith or coating on an inert support.

The material containing reducible metal is preferably a copper material. For example, the material may comprise >20% wt Cu. Most preferably the material containing metal in reducible form is a particulate copper-zinc alumina material containing 25-35% wt CuO, 30-60% wt ZnO and 5-40% Al₂O₃%.

Alternatively the material may be a finely divided iron material. All the materials may optionally comprise precious metal promoters that may assist in the reduction process.

The oxidation of the reduced Ni, Co, Cu, Fe, Mn or Ag by the free oxygen present in the hydrocarbon is preferably performed at ≦300° C., more preferably ≦200° C., most preferably ≦150° C., especially <100° C., e.g. between −10 and 100° C.

In the present invention, a side stream portion of gaseous hydrocarbon containing free oxygen is continuously or periodically withdrawn, from e.g. a pipeline, used to form a hydrogen-containing gas mixture by ATR, cDH, POx or cPOx and this mixture, optionally following a step of water-gas-shift, passed over the material containing reducible metal. The volume of side stream withdrawn is preferably only enough to generate sufficient hydrogen and/or carbon monoxide required to reduce the reducible metal in the material. The portion withdrawn is therefore preferably ≦20%, more preferably ≦10%, most preferably ≦5% by volume of the gaseous hydrocarbon stream. A portion of the hydrogen-containing gas may if desired be subjected to a step of hydrogen separation e.g. using suitable membrane technology, and the recovered hydrogen sent upstream, e.g. for hydrodesulphurization purposes.

In a preferred embodiment, the hydrocarbon containing free oxygen is natural gas, i.e. a methane-rich gas stream containing minor amounts of C2+ hydrocarbons. The natural gas may be a “raw” natural gas as recovered from subterranean sources or may be a “process” natural gas that has been used in a process, such as a stripping gas. Natural gas liquids (NGLs) may also be used.

If desired, sulphur and optionally mercury or arsenic absorbers may be provided, e.g. upstream of the hydrogen generation step, to remove poisons from the hydrocarbon used to form the hydrogen containing gas and so protect any catalysts used therein from poisoning. Suitable sulphur absorbers include zinc oxide compositions, preferably copper-containing zinc oxide compositions whereas mercury and arsenic are usefully absorbed on metal sulphides such as copper sulphide. Particularly suitable sulphur and mercury absorbents are described in EP0243052 and EP0480603. Additionally, hydrodesulphurization may also be performed upstream of any adsorbents, using known Ni or Co catalysts to convert organic-sulphur, -nitrogen-mercury and -arsenic compounds into more readily removable materials such as H₂S, NH₃, Hg and AsH₃.

Although upstream sulphur removal may be desirable to protect the downstream catalysts, in cases where a precious metal reforming catalyst is employed upstream of a water gas shift catalyst, it may be desirable in addition or as an alternative to include a sulphur absorbent between the reforming catalyst and water-gas shift catalyst.

In a particularly preferred process, a side-stream of natural gas is withdrawn and used to generate the hydrogen containing gas mixture.

The apparatus used for the process of the present invention may be conveniently compact, in particular where side-stream partial combustion is affected.

Accordingly, the invention further provides apparatus for reducing the free oxygen content of a gaseous hydrocarbon stream, comprising an oxygen removal vessel having free-oxygen-containing gaseous hydrocarbon inlet means, product gas outlet means, and a Ni, Co, Cu, Fe, Mn or Ag material disposed within said vessel between said inlet and outlet means, wherein hydrogen formation means are operatively connected to the free-oxygen-containing gaseous hydrocarbon stream and said vessel such that said hydrogen-containing gas may be passed over said material.

The hydrogen formation means may comprise a catalytic dehydrogenation vessel having hydrocarbon inlet means, product gas outlet means and containing a dehydrogenation catalyst disposed between said inlet and outlet means.

Alternatively, the hydrogen formation means may comprise an autothermal reformer having hydrocarbon and steam inlet means, an oxygen-containing gas inlet means, product gas outlet means with oxidation means and, downstream, of said oxidation means a steam reforming catalyst, both disposed between said inlet and outlet means. The oxidation means may comprise a combustion burner or a partial oxidation catalyst.

Preferably, the hydrogen formation means comprise a partial combustion vessel, having hydrocarbon and oxygen-containing gas inlet means, product gas outlet means and optionally containing a partial oxidation catalyst disposed between said inlet and outlet means.

In one embodiment a water-gas-shift vessel containing a water-gas shift catalyst may be operatively connected between the partial combustion vessel or autothermal reforming vessel and the oxygen removal vessel so that the gaseous product stream from the partial combustion vessel or autothermal reforming vessel may be enriched with hydrogen before being passed to the oxygen removal vessel.

It is desirable that any apparatus used to generate hydrogen is compact so as to facilitate off-shore as well as on-shore installation. In particular, reforming and shift stages may be combined in compact hydrogen-generation apparatus wherein a hydrocarbon and oxygen are combined over a precious metal partial oxidation catalyst, which may also function as a catalyst for the steam reforming reactions, and the resulting reformed gas mixture cooled and passed over a suitable water-gas shift catalyst. Cooling of the reformed gas mixture may be performed using heat exchange means, such as cooling coils, plates or tubes, or by direct injection of water. Hence in a preferred embodiment, the hydrogen generation apparatus comprises a vessel in which is disposed a supported precious metal reforming catalyst and a separate supported water-gas shift catalyst with heat exchange tubes or plate between the catalysts. The hydrocarbon is fed, with an oxygen-containing gas and steam, to the reforming catalyst where oxidation and steam reforming reactions take place. The resulting reformed gas mixture containing hydrogen, carbon oxides steam and a small amount of unreacted hydrocarbon is then cooled by the heat exchange coils or plate and passed over the water-gas shift catalyst to increase the hydrogen content of the hydrogen-containing gas. The use of hydrogen generation apparatus comprising both reforming and shift catalysts is preferred in that it is very compact and may therefore readily be installed in off-shore as well as onshore facilities such as oil production platforms. We have found that reforming apparatus designed for fuel cell hydrogen generation is particularly suited to the present invention due to its relatively small size. Suitable apparatus for autothermal reforming is described in EP0262947 and Platinum Met. Rev. 2000, 44 (3), 108-111, and is known as the HotSpot™ reformer.

In the present invention, the hydrogen formation means are operatively connected to the free-oxygen-containing gaseous hydrocarbon stream, so that the hydrogen formation means are fed with a side-stream of the free oxygen-containing gaseous hydrocarbon. The flow of side-stream hydrocarbon to the hydrogen forming means may be controlled by means of suitable valves.

If desired, suitable heat exchanger means may be provided to cool the gaseous product stream from the hydrogen forming means to prevent decomposition of the reduced metal material.

The invention is further illustrated by reference to the drawings in which

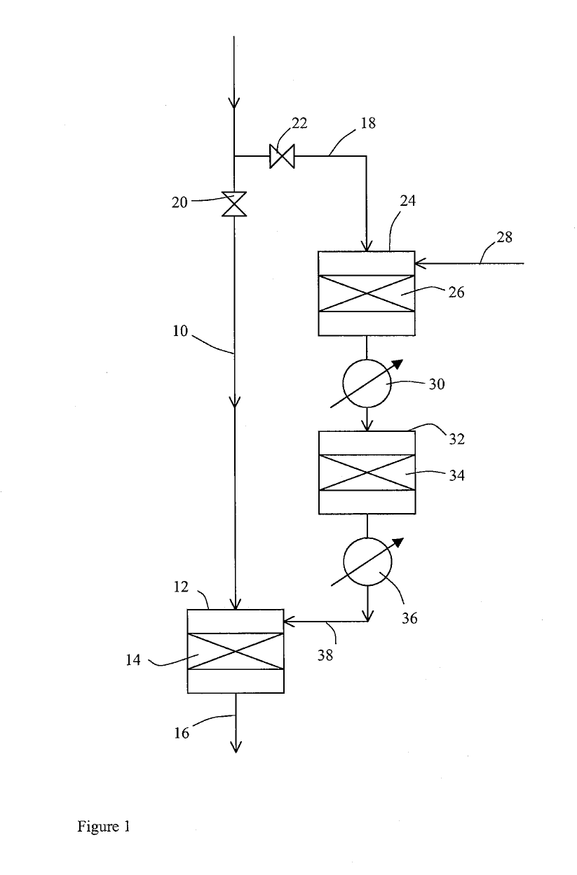

FIG. 1 is a flowsheet of one embodiment of the process of the present invention and

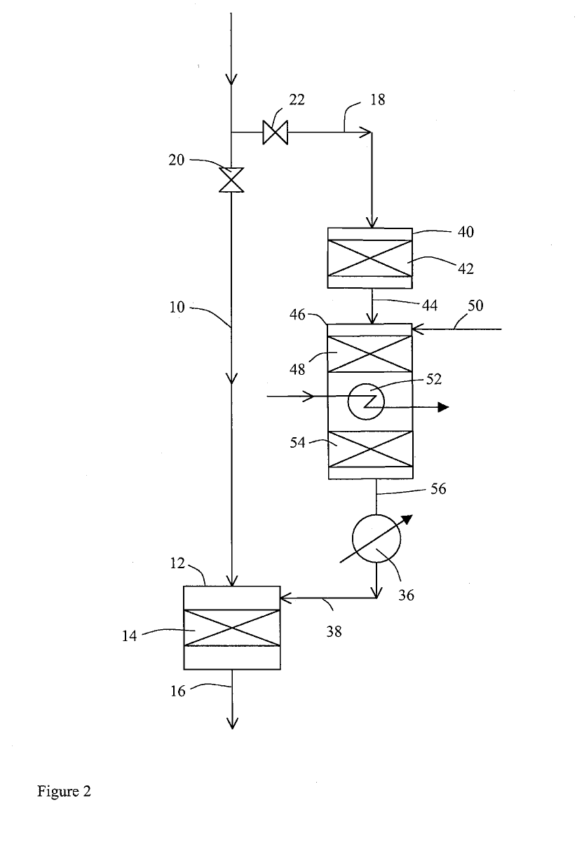

FIG. 2 is a flowsheet of an alternative embodiment wherein the hydrogen generation and shift reactions take place within the same vessel.

In FIG. 1, a natural gas containing 70-100 ppm free oxygen is fed via line 10 at ambient temperature to an oxygen removal vessel 12 where it passes through a bed of particulate supported reduced copper material 14. The level of free oxygen in product stream 16 leaving vessel 12 is reduced to <5 ppm and the copper is oxidised. When the free oxygen content of the hydrocarbon passing through the copper material increases to >5 ppm, a side-stream line 18 upstream of the vessel 12 is used to withdraw a portion of the oxygen-containing natural gas from line 10. The amount of natural gas withdrawn via line 18 is controlled by valves 20 in line 10 and 22 in line 18. The withdrawn portion (≦20% vol) is fed via line 18 to a partial combustion vessel 24 in which is disposed a precious metal partial oxidation catalyst 26. Air is fed via line 28 to combustion vessel 24. The oxygen in the air 28 reacts with the hydrocarbon feed over the catalyst 26 to provide a gaseous product stream comprising hydrogen, carbon monoxide, steam and carbon dioxide. The gaseous product stream emerging from combustion vessel 24 is cooled in heat exchanger 30 and then passed to water gas shift vessel 32 containing a bed of copper-based water-gas shift catalyst 34. The hydrogen content of the partially combusted gas stream is increased over the water gas shift catalyst. The hydrogen-enriched gas stream is passed from vessel 32, via heat exchanger 36 and line 38 to vessel 12 where it is passes over the oxidised copper material a and reduces the oxidised copper.

In FIG. 2, a natural gas containing 70-100 ppm free oxygen is fed via line 10 at ambient temperature to an oxygen removal vessel 12 where it passes through a bed of particulate supported reduced copper material 14. The level of free oxygen in product stream 16 leaving vessel 12 is reduced to <5 ppm and the copper is oxidised. When the free oxygen content of the hydrocarbon passing through the copper material increases to >5 ppm, a side-stream line 18 upstream of the vessel 12 is used to withdraw a portion of the oxygen-containing natural gas from line 10. The amount of natural gas withdrawn via line 18 is controlled by valves 20 in line 10 and 22 in line 18. The withdrawn portion (≦20% vol) is fed via line 18 to a purification vessel 40, containing a particulate copper-zinc oxide composition 42 that removes hydrogen sulphide from the gas stream. The desulphurised gas is then preheated by means of a heat exchanger (not shown) and fed via line 44 to hydrogen generation vessel 46 containing a monolithic Rh on Ceria-doped zirconia reforming catalyst 48. The desulphurised gas is mixed with oxygen and steam fed to the hydrogen generation vessel 46 via line 50 and the mixture autothermally reformed (oxidised and steam reformed) over the catalyst 48. The catalyst catalyses both the combustion and steam reforming reactions. The reformed gas stream comprising hydrogen, steam and carbon oxides, is cooled by means of heat exchange tubes 52 within the vessel 46 downstream of the reforming catalyst 48. The cooled gases then pass to a bed of low-temperature shift catalyst 54 disposed within vessel 46 downstream of said heat exchange tubes 52. The cooled gas mixture reacts over the catalyst 54 to increase the hydrogen content of the gas mixture by the water-gas shift reaction.

The hydrogen-enriched gas stream is passed from vessel 46, via line 56 to heat exchanger 36 and then line 38 to vessel 12 where it is passes over the oxidised copper material and reduces the oxidised copper.

1. A process for reducing free oxygen in a gaseous hydrocarbon stream, comprising the step of passing the gaseous hydrocarbon stream over a material comprising a metal selected from the group consisting of Ni, Co, Cu, Fe, Mn and Ag in a reduced state so that oxygen present in said stream reacts with the metal, wherein the metal in the reduced state is formed by,
(i) withdrawing a portion of the hydrocarbon stream,
(ii) forming a gas mixture containing hydrogen from the hydrocarbon portion, and
(iii) passing the gas mixture containing hydrogen over the material containing the metal in reducible form.

2. A process according to claim 1 wherein the hydrogen-containing gas mixture is formed in a step of catalytic dehydrogenation over oxidic or precious metal catalysts.

3. A process according to claim 1 wherein the hydrogen-containing gas mixture is formed by autothermal reforming comprising a step of partial oxidation of a hydrocarbon/steam mixture with an oxygen containing gas optionally over an oxidation catalyst and steam reforming the resulting gas mixture directly over a bed of a supported Ni or precious metal steam reforming catalyst.

4. A process according to claim 3 wherein the oxidation and steam reforming catalysts are both a supported precious metal catalyst.

5. A process according to claim 1 wherein the hydrogen containing gas mixture is formed by partially oxidising a hydrocarbon with an oxygen containing gas.

6. A process according to claim 5 wherein the partial oxidation of hydrocarbon is performed in the absence of a partial oxidation catalyst.

7. A process according to claim 5 wherein the partial oxidation of hydrocarbon is performed in the presence of a partial oxidation catalyst.

8. A process according to claim 7 wherein the partial oxidation catalyst is a supported precious metal oxidation catalyst.

9. A process according to claim 3 wherein the hydrogen-containing gas mixture is subjected to the water gas shift reaction over a water-gas-shift catalyst to increase the hydrogen content of the gas mixture.

10. A process according to claim 1 wherein the metal in the reduced state is formed periodically.

11. A process according to claim 1 wherein the hydrocarbon containing free oxygen is a natural gas.

12. A process according to claim 1 wherein the metal material is a copper material containing ≧20% wt copper.

13. A process according to claim 1 wherein the metal material is a finely divided iron material.

14. A process according to claim 1 wherein the hydrocarbon containing free oxygen is passed over the metal material at a temperature ≦300° C.

15. A process according to claim 1 wherein sulphur and optionally mercury or arsenic absorbers are provided upstream of the hydrogen formation step to remove poisons from the hydrocarbon used to form the hydrogen-containing gas.

16. A process according to claim 9 wherein a sulphur absorber is provided upstream of the water-gas shift catalyst.

17. Apparatus for reducing the free oxygen content of a gaseous hydrocarbon stream, comprising an oxygen removal vessel having free-oxygen-containing gaseous hydrocarbon inlet means, product gas outlet means, and a Ni, Co, Cu, Fe, Mn or Ag material disposed within said vessel between said inlet and outlet means, wherein hydrogen formation means are operatively connected to the free-oxygen-containing gaseous hydrocarbon stream and said vessel such that said hydrogen-containing gas may be passed over said material.

18. Apparatus according to claim 17 wherein the hydrogen formation means comprise a catalytic dehydrogenation vessel having hydrocarbon inlet means, product gas outlet means and containing a dehydrogenation catalyst disposed between said inlet and outlet means.

19. Apparatus according to claim 17 wherein the hydrogen formation means comprise an autothermal reformer having hydrocarbon inlet means, steam inlet means, an oxygen-containing gas inlet means, product gas outlet means and disposed between the inlet and outlet means, a partial oxidation means and a steam reforming catalyst.

20. Apparatus according to claim 17 wherein the hydrogen formation means comprise a partial combustion vessel, having hydrocarbon and oxygen-containing gas inlet means and product gas outlet means.

21. Apparatus according to claim 19 wherein a water-gas-shift vessel containing a water-gas shift catalyst is operatively connected between the autothermal reformer and the oxygen removal vessel so that the gaseous product stream from the autothermal reformer may be enriched with hydrogen before being passed to the oxygen removal vessel.

22. Apparatus according to claim 17 wherein the hydrogen formation means comprises a vessel having hydrocarbon inlet means, steam and oxygen inlet means and product gas outlet means, and disposed between said inlet and outlet means a partial oxidation catalyst upstream of cooling means, and a water gas shift catalyst downstream of said cooling means.

23. Apparatus according to claim 17 wherein control means are provided that permit periodic withdrawal of gaseous hydrocarbon to said hydrogen formation means.

24. Apparatus according to claim 17 wherein heat exchanger means are provided to cool the hydrogen-containing gas from the hydrogen formation means to prevent decomposition of the free-oxygen-containing gaseous hydrocarbon, and to prevent damage to the water-gas-shift catalyst if present.

25. Apparatus according to claim 17 wherein the hydrogen formation means comprise a partial combustion vessel, having hydrocarbon and oxygen-containing gas inlet means, product gas outlet means and a partial oxidation catalyst between said inlet and outlet means.

26. Apparatus according to claim 20 wherein a water-gas-shift vessel containing a water-gas shift catalyst is operatively connected between the partial combustion vessel and the oxygen removal vessel so that the gaseous product stream from the partial combustion vessel may be enriched with hydrogen before being passed to the oxygen removal vessel.

27. Apparatus according to claim 17 wherein the hydrogen formation means comprises a vessel having hydrocarbon inlet means, steam and oxygen inlet means and product gas outlet means, and disposed between said inlet and outlet means a partial oxidation catalyst, which also functions as a steam reforming catalyst, upstream of cooling means, and a water gas shift catalyst downstream of said cooling means.

28. A process according to claim 13, wherein the finely divided iron material comprises precious metal promoters.
